(19) United States
(12) Patent Application Publication
(10) Pub. No.: US 2022/0317738 A1
(43) Pub. Date: Oct. 6, 2022

(54) TOUCHSCREEN OVERLAY APPARATUS

(71) Applicant: Youcef SAMER, Antwerpen (BE)

(72) Inventor: Youcef SAMER, Antwerpen (BE)

(21) Appl. No.: 17/615,898

(22) PCT Filed: Jun. 4, 2020
(86) PCT No.: PCT/EP2020/065542

§ 371 Date: Dec. 2, 2021

(30) Foreign Application Priority Data
Jun. 4, 2019 (EP) PCT/EP2019/064454
Feb. 10, 2020 (EP) PCT/EP2020/053355
Apr. 8, 2020 (CN) CN202020513272.2

(51) Int. Cl. G06F 1/16; G06F 3/039

(52) U.S. Cl. CPC G06F 1/1656; G06F 1/1681; G06F 3/0393; G06F 2200/1633

(57) ABSTRACT

The present invention concerns to a cover for devices comprising a capacitive touchscreen, suitable for assisting a user with touch interaction on said touchscreen by the electrical connecting the user interaction point and the contact point.

### TECHNICAL FIELD

The present invention relates to a cover for devices comprising a capacitive touchscreen, in particular is suitable for assisting a user with touch interaction on said touchscreen.

### BACKGROUND

Mobile electronic devices with capacitive touchscreen, such as smartphones and tablets, are widely used throughout the world nowadays. Examples of representative products are iPhones, iPods and iPads of Apple Inc. of USA, and Android phones and tablets manufactured by the American internet search engine company, Google.

The most important feature of these devices is the use of a touchscreen allowing the use of the fingers. For instance, these devices enable games to be easily downloaded using an application store or the like, and thereby allow a user to enjoy various games. However, since an input operation should be performed by a virtual button that is shown on a front touchscreen so as to manipulate a game, it is difficult to rapidly and precisely perform the input operation. Also, the accuracy of the virtual button operation is not as good as, for example, a physical game handle, and the user's finger can block the sight and affect the display effect. Moreover, a user cannot experience a desirable grip sensation during the operation.

Not only in games, but also in other occurrences where multiple virtual buttons need to be operated in random orders and/or combinations, especially those that need a finger operation across the touchscreen, assistance is desired.

On the other hand, a protection cover for the device's (smartphones, tablets, etc.) body and touchscreen from scratch and wear, often comes with the device itself. There is a desire that such cover shall offer enough protection to the device, and meanwhile it does not significantly increase the dimension and weight after assembled on the device.

There are products available on the market that aim to solve mentioned problems. CN108339269 provides a modular gamepad used for a smart phone, wherein the modular gamepad is arranged on a rear shell of the smart phone, a gamepad rear shell and the rear shell of the smart phone are in contact attaching, and the modular gamepad is detachably connected with the smart phone, and can be separated from the smart phone when not in use. However, this gamepad first requires external battery, which comes with extra weight and manufacturing cost. Second, the gamepad requires to be matched with the games such all the buttons on the gamepad are paired with a function in the game. It restricts the use of the invention only in appointed games.

CN208079192 provides a cell phone protection shell type mobile games peripheral hardware, comprising a housing, at least one side angle of casing is equipped with the recreation button, wherein the recreation button is connected with the cell phone using wired and/or radio communication through a chip. However, the establishment needs a special setting to connect the recreation button and virtual button on the screen. And it requires external battery for the chip. It increases the manufacturing cost and the learning cost for a user.

WO2009036375 offers a user control device suitable for use in cooperation with information systems. In one of the embodiments (FIG. 6B), it offers a cover for a smartphone that contains physical buttons on the surface that is above the touchscreen, wherein the cover transfer the button pressing into screen touching so as to assist the touchscreen operation. It however, first significantly increases the dimension and weight after assembled to a smartphone. Second, it does not solve the problem that touching operation blocks the sight of a user.

The current gap for designing a cover for devices comprising a touchscreen is that it shall i) assist a touch interaction; ii) is easy to operate and assemble; iii) not increase the dimension and weight significantly; iv) possibly protect the electronic device; v) come with simple design and low manufacturing cost.

### SUMMARY OF THE INVENTION

The invention provides a cover for electronic devices comprising a capacitive touchscreen, suitable for assisting a user with touch interaction on said touchscreen, comprising:
a body suitable for at least partly embracing the device at at least one or more edges and/or back of the device;
at least one user interaction point on the edge and/or the back of the body, which comprises an exposed electrically conductive element;
at least one contact point, which comprises an exposed electrically conductive element;
a connection electrically linking the electrically conductive element of the user interaction point to the electrically conductive element of the contact point;
   wherein at least part of the cover covers the touchscreen, wherein the contact point is positioned at a part of the cover which covers the touchscreen, preferably at the side of said part of the cover that faces the touchscreen.

The invention also provides another two different versions (version 2 and version 3) of the invention from the first aspect, in a subject in need thereof, the two variations further comprising a detachable front panel that covers the touchscreen, wherein the contact point is positioned on the front panel.

The inventor has thus realized a cover suitable for assisting a user with touch interaction on a capacitive touchscreen in an electronic device, in which the cover transfer the static electricity from the finger to the contact point via conductive elements, and thus allow the user to virtually touch the touchscreen.

### DESCRIPTION OF FIGURES

FIG. 1A shows schematically a perspective view of the cover of a first version.

FIG. 1B shows schematically a top view of the cover of FIG. 1A.

FIG. 2A shows schematically a perspective view of the cover of FIG. 1A when assembled on a smartphone.

FIG. 2B shows schematically a perspective view of FIG. 2A from a different angle.

FIG. 2C shows schematically a perspective view of FIG. 2A in different layers before assembled on a smartphone.

FIG. 2D shows schematically a perspective view of FIG. 2C from a different angle.

FIG. 3A shows schematically a perspective view of the user interaction point, the electrical connection and the contact point in one preferred embodiment.

FIG. 3B shows schematically a sectional view of FIG. 3A.

FIG. 4A shows schematically a perspective view of the cover of a second version.

FIG. 4B shows schematically a perspective view of the cover of FIG. 4A when the front panel is apart from the base cover.

FIG. 5A shows schematically a perspective view of the cover of FIG. 4A when assembling on a smartphone.

FIG. 5B shows schematically a perspective view of FIG. 5A in different layers before assembled on a smartphone.

FIG. 6A shows schematically a perspective view of the cover of a second version in another preferred embodiment where the front panel can flip.

FIG. 6B shows schematically a perspective view of the cover of FIG. 6A when the flip front panel is open.

FIG. 7A shows schematically a perspective view of the cover of a third version.

FIG. 7B shows schematically a perspective view of the cover of FIG. 7A when the front panel is apart from the base cover.

FIG. 8A shows schematically a perspective view of the cover of FIG. 7A when assembling on a smartphone.

FIG. 8B shows schematically a perspective view of FIG. 8A in different layers before assembled on a smartphone.

FIG. 9A shows a perspective view of a cover according to an embodiment of the invention for combination with a smartphone.

FIG. 9B and FIG. 9C show perspective views of the front panel of the cover of FIG. 9A.

FIGS. 10A, 10B and 10C show detailed views of a user interaction point according to an embodiment of the invention.

### DETAILED DESCRIPTION OF THE INVENTION

The present invention concerns a cover suitable for assisting a user with touch interaction on a capacitive touchscreen in an electronic device.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Cover Version 1

The invention provides a cover for electronic devices comprising a capacitive touchscreen, suitable for assisting a user with touch interaction on said touchscreen, comprising:
a body suitable for at least partly embracing the device at at least one or more edges and/or back of the device;
at least one user interaction point on the edge and/or the back of the body, which comprises an exposed electrically conductive element;
at least one contact point, which comprises an exposed electrically conductive element;
a connection electrically linking the electrically conductive element of the user interaction point to the electrically conductive element of the contact point;
   wherein at least part of the cover covers the touchscreen, wherein the contact point is positioned at a part of the cover which covers the touchscreen, preferably at the side of said part of the cover that faces the touchscreen.

The inventor has thus realized a cover suitable for assisting a user with touch interaction on a capacitive touchscreen in an electronic device, in which the cover transfer the static electricity from the finger to the contact point via conductive elements, and thus allow the user to virtually touch the touchscreen.

In a preferred embodiment, the body (3) of the present invention is first able to cover the touchscreen (11) in an electronic device, at least part of the touchscreen, preferably close to the edges of the touchscreen. Wherein at least one contact point (4) is positioned on the body that covers the touchscreen. The body (3) embraces the electronic device (6) at at least one or more edges and/or back of the device. In any case, it is to ensure that when assembled on an electronic device, there is no plane displacement (horizontal or vertical) of the cover (1), such that the cover stays fixed. There is at least one user interaction point (2) positioned on the edge and/or the back of the body, preferably on the edge of the body. In a preferred embodiment, the cover further comprises at least one magnets or (Ferro) metal part at the back, such that it could be placed on other types of covers.

In a preferred embodiment, the body, at least the part that able to cover the touchscreen, is (substantially entirely) transparent (for instance, hardened glass), such that the present invention does not affect user's sight when using the touchscreen (11). The part of the cover where the contact point (4) is positioned is accordingly also transparent for the same reason. This part of the cover and the contact point can for instance comprise (or even consist of) indium tin oxide (ITO). The body (3) comprises at least one layer, preferably two layers or more, wherein the contact point is positioned on the layer that is closest to the touchscreen when the cover (1) assembled to an electronic devices. The body, at least the part that able to cover the touchscreen, and the contact point (4) are parallel to the touchscreen, namely flat. Such that when assembled on an electronic device, a rugged surface is avoided.

Preferably the user interaction point (2) and the contact point (4) are paired with each other, and linked by an electrical connection (5). Both said user interaction point (2) and said contact point (4) comprises an electrically conductive element that is exposed. Thus an electrical circuit is built between the electrically conductive element in the user interaction point (2) and the electrically conductive element in the contact point (4). Such that when a user touches a finger on the user interaction point (2), specifically the electrically conductive element, the static electricity is transferred from the user's finger to the contact point (4), specifically the electrically conductive element. In this way, the user touches the touchscreen (11) virtually. Present invention offers one or more pairs of the user interaction point (2) and the contact point (4), preferably two pairs.

The user interaction point (2), the contact point (4) and the electrical connection (5) are not intended to be positioned at the part of the body (3) that presents right in front of the center of the touchscreen (11). Instead, it is preferred to keep them close to the edges. This way, they do not affect user's sight when using the touchscreen. In a preferred embodiment, the contact point (4) and the electrical connection (5) are on the body that covers the touch screen, and are close to the edge. Whereas the user interaction point (2) is positioned on the same edge or at the back of the cover (1).

In one preferred embodiment, the user interaction point (2) comprises a mechanical actuator (8), which comprises an electrically conductive component (9) and an insulator housing (10). The actuator (8) is adapted to move upon exertion of force in a first direction, whereby movement in said first direction establishes an electrical connection between the electrically conductive component (9) of the actuator (8) and the electrical connection (5), and eventually the electrically conductive element of the user interaction point (4). In another preferred embodiment, the user interaction point (2) is an essentially stationary touch point, namely the electrically conductive component (9) is fixedly connected with the electrical connection (5). In any case, it is to confer a responding force to the user's finger when a user touches the user interaction point (2), essentially confers a push/tap experience to the user. In a further preferred embodiment, the user interaction point (2) is is adapted to be repositioned on the cover, such that a user can adjust it according to the hand size and user preference. This can be achieved by a variety of means, for instance, by having the user interaction points themselves being removably attachable to the cover (glue, magnet, etc. for attachment) at either fixed positions or continuous positions. The electric connector can be modified to allow this implementation, for instance by extending over a certain region of the cover, thereby allowing connection to the user interaction points at a number of positions.

The contact point (4) comprises an electrically conductive element that receives the static electricity from the user's finger, thereby operating as a proxy for the user's finger, which is used to operate a certain point on the touchscreen (11). One challenge for the contact point is to reinforce the static electricity that applies on said point, essentially the electric field that applied on said point. In a preferred embodiment, a coiled conductor is, for instance, used for above said purpose.

As mentioned above, to meet the user's expectations, the cover (1) is desired to be thin and light. The cover (1) is also expected to be easily adapted to an electronic device and stiff enough to protect the contact point (4), for instance. Typical material to manufacture present invention comprises plastic, resin rubber, and other standard materials. Moreover, the thickness of the cover, at least the part that covers the touchscreen, preferably is not over 4 mm.

Present invention is a cover (1) for an electronic device (6) that comprises a touchscreen (11), suitable for assisting a user with touch interaction on said touchscreen. In a preferred embodiment, said device (6) is a handhold device that is suitable to operate with merely two hands. The aim of present invention is to assist the user with touch interaction, while the two hands stay in a relatively fixed position. It is essential to keep the virtual buttons on the touch screen and the user interaction point (2) within the fingers reach range. For example, in a preferred embodiment, when present invention assembled on an electronic device (6), the virtual buttons on the touch screen are for the thumbs, the user interaction point (2) is reachable for the forefinger.

In a preferred embodiment, the first version of present invention is assembled to an electronic device (6) optionally with a coordinating base cover (7), which offers additional cover to the back of said device (6). In principle, the base cover (7) can be any cover that is suitable to cover the back of the device (6). It nevertheless needs to consider the coordination at the part where the base cover (7) contacts said cover (1), if it happens thereof.

Additionally, present invention comprises openings on the body (3), preferably on the edge, that is suitable for operating actuators (e.g.: volume button, on/off button) and the passage of electric wiring for the electronic device (6) (e.g.: charging cable, headset cable, data transmission cable). It nevertheless shall match the designated electronic devices.

When the first version of current invention is in use, a user needs to first apply the cover (1) to an electronic device (6), specifically the contact point is facing the touchscreen (11). Then the user often needs to move the virtual button on the touchscreen to the contact point (4). In a preferred embodiment, where the contact point (4) is substantially invisible, an indicator of the position of the contact point (4) can be formed by a thickening on the surface at the corresponding position. Thus the virtual button on the touchscreen (11) needs to be moved to the thickening indicator in this occurrence. In a further preferred embodiment, the user can further adjust interaction point according to the hand size and user preference. Then the assembling of the cover (1) and the electronic device is finished.

In a particular embodiment, the body comprises a front part or front panel for covering the touchscreen of the electronic device, whereby said front part or front panel is hingedly attached to the rest of the body, and whereby preferably the electric connection between the (electrically conductive elements of the) interaction point and the contact point is achieved via the hinge attachments.

The following features are applicable to each aspect or version of the cover, and such combinations form part of the content of the application:

In a preferred embodiment, the cover is provided with a protective layer at its outer surface at least at the contact points, said protective layer covering said contact points. In some embodiments, the protective layer will cover a substantial part, up to 70, 80, 90 or even 100%, of the part of the cover facing the touchscreen. In other embodiments, the protective layer is only present at a restricted area at and optionally directly adjacent to the contact points. The protective layer can be provided in two or more separate areas, each covering one or more contact points. Preferably, the connection, or at least the part of it that is situated in/on the cover is also covered by the protective layer, at least the part of the cover that is facing the touchscreen.

The protective layer may be a (reinforcing) foil, a chemical layer (oil) or others.

In a preferred embodiment, part of the connection extends across the side surface of the cover (facing the sides of the electronic device). Preferably, this is maximized, reducing the length of the connection that extends through the part of the cover facing the touchscreen, this way avoiding reduction of sight and reducing chance of accidental damage to said connections.

In a preferred embodiment, the contact points and/or the connections are printed on the cover. In a preferred embodiment, the contact points and/or the connections are glued on the cover. In some embodiments, the two above are combined wherein the contact points or the connections are printed, and the other is glued.

In certain embodiments, the connections are essentially electric conductors that are integrated in (one of the layers of) the cover. This can be achieved by, during fabrication of the cover, introducing fine electric conductors in the material of the cover while it is hardening in order to define the connector path. Typical materials used in covers are glass and plastics, which allow easy introduction of the conductors during production.

In some embodiments, at least part of the cover, preferably the part facing the touchscreen, comprises two or more layers, wherein the contact points (and preferably also at least part of the connections) are provided in or on one of the layers, preferably a layer proximal (or more proximal) to the touchscreen when the cover is in place. By providing the more fragile circuitry at a lower layer that is not directly touched by a user when using the cover, a higher amount of protection is ensured. The layers may comprise or consist of glass, plastics and other materials.

In an embodiment, one or more of the user interactions points are double buttons, wherein only one button can be activated at once. This can be achieved via a so-called seesaw button, wherein the double button is a rigid piece positioned over a fulcrum, allowing it to be tilted at both sides over the fulcrum, wherein tilting towards one side activates the first button, and tilting towards the other side activates the second button.

In some embodiments, spring members or resistance members may be provided at each side to dampen the tilting. In some embodiments, activation of one or both buttons produces an audible sound for the user, such as a ‘click’, and/or sudden tactile feedback, which can be enacted by selection of certain types of buttons.

In certain embodiments, the cover can be provided with additional components, preferably in the part of the cover that covers the backside of the device when in position. Said additional components may be an extra power source capable of powering and/or charging the power source internal to the device via induction. Other or additional components may comprise: a cooling device, a wallet and/or others.

In certain embodiments, and in particular in the case of glued components as discussed previously, the user interaction points comprises a static discharge element, which is adapted to contact another component when the user interaction points are released by a user to discharge any remaining static electricity. By adapting the user interaction points to ground themselves when in resting position or when returning to a resting position (i.e., after or without interaction of a user), static charges are removed.

In certain embodiments, the user interaction points can be disabled and enabled. This can be achieved via a number of ways. For instance, providing slidable user interaction points, providing blocking elements which can be removably positioned to deny activation of one or more buttons (for instance non-conductive element moving between user interaction point and connection), user interaction points which can be removed and placed back on the cover, preferably via a pairing element that electrically couples the removable user interaction point to the connection, and others.

In certain embodiments of the invention, connections/conductors are provided at the side of the cover, and provide for electric connection points which can be used for enabling other add-ons, such as external keyboards and the like. Preferably, this can be coupled with an app or setting on the smartphone (or other electronic device) that ‘activates’ the external keyboard mode, this way ensuring that the input received via the connections/conductors is interpreted correctly by the smartphone.

Cover Version 2

A cover for devices comprising a capacitive touchscreen, suitable for assisting a user with touch interaction on said touchscreen, comprising:
a body suitable for at least partly embracing the device at at least one or more edges and/or back of the device, comprising:
   at least one user interaction point on the edge and/or the back of the body, which comprises an exposed electrically conductive element;
   at least one electric connector electrically linked to the electrically conductive element of the user interaction point;
a front panel suitable for at least partly covering the touchscreen, and is adapted for being detachably connectable to the body, comprising;
   at least one contact point on the front panel that comprises an exposed electrically conductive element;
   at least one electric connector electrically linked to said contact point;
      wherein the contact point is preferably positioned at the side of the front panel that faces the touchscreen, wherein the an electric connection is established between the electric connectors of the front panel and the body when said body and said panel are assembled.

In a preferred embodiment, the front panel is hingedly attachable to the body around a hinge axis, optionally via a magnetic interaction between the two, preferably whereby the hinge axis is positioned at the edge of the electrical connector electrically linked to the contact point and the user interaction point.

In a further preferred embodiment, the front panel and the body can be magnetically coupled (via magnet and magnetic material) at at least one of their edges, and preferably four edges, to form a casing adapted to size and dimension of the electronic device.

In a preferred embodiment, the body (17) of the second version embraces the electronic device (6) at at least one or more edges and/or back of the device. There is at least one user interaction point (2) positioned on the edge and/or the back of the body, preferably on the edge of the body (17). The body (17) comprises at least one electric connector (15), that is exposed and electrically linked to the user interaction point (2). In a preferred embodiment, the body (17) further comprises at least one magnets or (Ferro) metal part at the back, such that it could be placed on other types of covers. The second version of a cover (1) further comprises a separate front panel comprising at least one contact point (4) and at least one electric connector (16) that is exposed and electrically linked to the contact point (4).

Preferably, said body (17) and said front panel (12) are adapted to be fixedly connected when assembled together. The connection may rely on magnetic force and/or mechanical force, and preferably comprises a hinging means, allowing the front panel to hingedly move with respect to the body around a hinge axis. In a preferred embodiment, the hinge axis is positioned at the edge of the electrical connector, and allows the conductive elements of the contact point and user interaction point to be electrically linked. It is crucial that when assembled, there is no plane displacement of the front panel (12). When assembled, the electronic device (6) is in between the front panel (12) and the body (17), with the touchscreen (11) facing the front panel (12). When not desired, said front panel (12) is detachable from said body (17).

Preferably, the front panel (12) is transparent (for instance, hardened glass), such that it does not affect user's sight when using the touchscreen (11). Accordingly, the contact point (4) is also transparent for the same reason. This part of the cover and the contact point can be formed by material which comprises indium tin oxide (ITO). The front panel (12) comprises at least one layer, preferably two layers or more. The contact point (4) is positioned on the layer (14) that is closest to the touchscreen (11) when assembled on an electronic device (6). The contact point (4) and the electric connector (16) are not intended to be positioned at the front panel (12) that presents right in front of the center of the touchscreen (11). Instead, it is preferred to keep them close to the edges. Such that they do not affect user's sight when using the touchscreen. The front panel (12), and the contact point (4) are parallel to the touchscreen, namely flat. Such that when assembled on an electronic device, a rugged surface is avoided.

The user interaction point (2) and contact point (4) may or may not follow the same design described in the first version of the cover (1).

Preferably, when the front panel (12) and the body (17) are assembled, the electric connector (15) in the body (17) and the electric connector (16) in the panel (12) are electrically connected. In other words, said user interaction point (2), said electric connector (15), said electric connector (16) and said contact point (4) are grouped. In a preferred embodiment, the cover (1) contains more than one set of above said group, preferably two sets of above said group.

Similar to the first version, the material for both the front panel (12) and the body (17) are meeting the user's requirements, as disclosed above. Similarly, the second version of the cover (1) is designated for a handhold electronic device that is suitable to operate with merely two hands. Further similarly, the body (17) comprises openings, preferably on the edge, that is suitable for operating actuators (e.g.: volume button, on/off button) and the passage of electric wiring for the electronic device (6) (e.g.: charging cable, headset cable, data transmission cable). It nevertheless shall match the designated electronic devices.

When the second version of current invention is in use, a user needs to first apply the body (17) to an electronic device (6) from its back. Then apply the front panel (12) to the touchscreen (11). Following, the user needs to move the virtual button on the touchscreen to the contact point (4). In a preferred embodiment, where the contact point (4) is substantially invisible, an indicator of the position of the contact point (4) can be formed by a thickening on the surface of the front panel (12) at the corresponding position. Thus the virtual button on the touchscreen (11) needs to be moved to the thickening indicator in this occurrence. In a further preferred embodiment, the user can further adjust interaction point according to the hand size and user preference. Then the assembling of the cover (1) and the electronic device is finished. When it is not desired, detach the front panel (12) from the body (17). The body can stay and be used as a normal cover.

Cover Version 3

A cover for devices comprising a capacitive touchscreen, suitable for assisting a user with touch interaction on said touchscreen, comprising:
a body suitable for at least partly embracing the device at at least one or more edges and/or back of the device;
a front panel suitable for at least partly covering the touchscreen, comprising;
   at least one user interaction point on the panel, which comprises an exposed electrically conductive element;
   at least one contact point on the front panel, said contact point comprising an exposed electrically conductive element;
   a connection electrically linking the electrically conductive element of the user interaction point and the electrically conductive element of the contact point;
      wherein the contact point is preferably positioned at the side of the front panel that faces the touchscreen, and wherein said front panel is adapted for being detachably connectable to the body.

In a preferred embodiment, the front panel (18) of the third version of present invention comprises at least one user interaction point (2) on the panel, at least one contact point (4) on the front panel, a connection (5) electrically linking said user interaction point (2) and said contact point (4), specifically the electrically conductive element on both.

Preferably, the front panel (18) is transparent (for instance, hardened glass), such that it does not affect user's sight when using the touchscreen (11). Accordingly, the contact point (4) is also transparent for the same reason. This part of the cover and the contact point can be formed by material which comprises indium tin oxide (ITO). The front panel (18) comprises at least one layer, preferably two layers or more. The contact point (4) is positioned on the layer (20) that is closest to the touchscreen (11) when assembled on an electronic device (6).

Preferably, said user interaction point (2), said contact point (4) and said connection (5) are grouped. The front panel comprises at least one of such group, preferably two. Said group is not intended to be positioned at the front panel (18) that presents right in front of the center of the touchscreen (11). Instead, it is preferred to keep them close to the edge. Such that they do not affect user's sight when using the touchscreen. The front panel (18), and the contact point (4) are parallel to the touchscreen, namely flat. Such that when assembled on an electronic device, a rugged surface is avoided.

In a preferred embodiment, the body (19) of the third version of present invention is suitable for at least partly embracing the device at at least one or more edges and/or back of the device. The body (19) comprises opening (22) suitable for hosting the user interaction point (2). In a preferred embodiment, the body (19) further comprises at least one magnet or (Ferro) metal part at the back, such that it could be placed on other types of covers.

Preferably, said body (19) and said front panel (18) are adapted to be fixedly connected when assembled together. The connection comprises magnetic force and/or mechanical force. It is crucial that when assembled, there is no plane displacement of the front panel (18). When assembled, the electronic device (6) is in between the front panel (18) and the body (19), with the touchscreen (11) facing the front panel (18). When not desired, said front panel (18) is detachable from said body (19)

The user interaction point (2), the connection (5) and the contact point (4) may or may not be following the same design described in the first and second version of the cover (1).

Similar to the first version, the material for both the front panel (18) and the body (19) are meeting the user's requirements, as disclosed above. Similarly, the second version of the cover (1) is designated for a handhold electronic device that is suitable to operate with merely two hands. Further similarly, the body (19) comprises openings, preferably on the edge, that is suitable for operating actuators (e.g.: volume button, on/off button) and the passage of electric wiring for the electronic device (6) (e.g.: charging cable, headset cable, data transmission cable). It nevertheless shall match the designated electronic devices.

In a particularly preferred embodiment, the cover defines an essentially cuboid shape, whereby, aside from the user interaction points, in essence no elements extend from said cuboid shape over a distance of more than 2 mm. It is the applicants aim to provide for a cover in its most simplistic design, thereby not significantly increasing dimensions of the electronic device held by it. Notwithstanding the user interaction points, the outer dimensions of the cover with respect to the inner dimensions defined thereby do not exceed 8 mm, preferably do not exceed 5 mm.

When the third version of current invention is in use, a user needs to first apply the body (19) to an electronic device (6) from its back. Then apply the front panel (18) to the touchscreen (11). Following, the user needs to move the virtual button on the touchscreen to the contact point (4). In a preferred embodiment, where the contact point (4) is substantially invisible, an indicator of the position of the contact point (4) can be formed by a thickening on the surface of the front panel (18) at the corresponding position. Thus the virtual button on the touchscreen (11) needs to be moved to the thickening indicator in this occurrence. In a further preferred embodiment, the user can further adjust interaction point according to the hand size and user preference. Then the assembling of the cover (1) and the electronic device is finished. When it is not desired, detach the front panel (18) from the body (19). The body can stay and be used as a normal cover.

In a further aspect of the invention, the cover comprises a body suitable for at least partly embracing the device at at least one or more edges and/or back of the device (although said body can in a possible adaptation be left out), the cover further comprises a front panel suitable for at least partly covering the touchscreen, said front panel comprising a flat front plane and one or more upstanding side sections at the edges of the front plane for embracing the device, the front panel comprising:
at least one user interaction point on one or more of the side sections of the front panel, which user interaction point comprises an exposed electrically conductive element;
at least one contact point on the front panel, said contact point comprising an exposed electrically conductive element;
a connection electrically linking the electrically conductive element of the user interaction point and the electrically conductive element of the contact point;
   wherein the contact point is positioned at the side of the front panel that faces the touchscreen, and wherein said front panel is adapted for being detachably connectable to the body, whereby the front panel and the body are essentially complimentary to each other.

The user interaction point may be static or movable. The connection linking electrically conductive element of the user interaction point to the electrically conductive element of the contact point (which serves as the fake finger interacting with the touch screen), can be pre-established (i.e. upon contact of the user with the electrically conductive element of the user interaction element, the electrically conductive element of the contact point is electrically connected to the user) or can be established upon further action (for instance applying a predetermined amount of pressure on the user interaction point, functioning as a button). By using a semi-enveloping front panel, the user interaction points can be positioned at the sides, allowing an easy interaction for the user.

In a preferred embodiment, the user interaction points comprise (one or more) actuators, said actuators comprising an electrically conductive path extending from a face of the side section at which the user interaction point is positioned facing outwardly from the front panel, to a face of said side section facing inwardly to the front panel, and wherein the actuator is adapted to, upon activation, establish an electrical connection between the electrically conductive element of the user interaction point to the electrically conductive path, whereby said electrically conductive element faces outwardly from the front plane, preferably whereby activation comprises moving at least part of the actuator towards the side section.

By extending the conductive path through the side section, it is ensured that the connection remains largely unseen and out of harm from the user.

In a further preferred embodiment, the electrically conductive path extends through at least part of the actuator.

In a preferred embodiment, the user interaction point comprises a mechanical actuator, whereby the actuator is adapted to move upon exertion of force towards the side section, whereby movement towards said side section establishes an electrical connection between the electrically conductive component of the actuator and the electrically conductive element of the user interaction point.

In a preferred embodiment, the connection is not exposed at the side of the front panel that faces the touchscreen over a minimal distance of 2.5 mm, preferably 5.0 mm, from the side section up to said side section. By covering this part of the connection, and preferably, it is ensured that the connection, which lies at the side of the front panel facing the touch screen, does not contact the device at these locations, which can be made (partly) of metal, and could ground any electric signal, thereby disabling the invention.

In a preferred embodiment, the upstanding side sections extend over at least 75%, preferably at least 90% of the perimeter of the front panel, said side sections extending upwards from the front panel over a distance of at least 1.0 mm, preferably at least 2.0 mm, more preferably at least 4.0 mm.

In a preferred embodiment, at least one user interaction point comprises at least two separated electrically conductive paths, each separated electrically conductive path connecting to a separate contact point, and wherein the user interaction point is adapted to, upon activation, establish an electrical connection from the electrically conductive element of the user interaction point to only one of said separated electrically conductive paths, preferably whereby said user interaction point comprises a hinging actuator.

In a specifically preferred embodiment, at least one user interaction point comprises an actuator, which comprises an movable element and a static element, wherein the movable element faces outwardly from the side section at which it is positioned, and wherein the actuator comprises at least one biasing element positioned between the movable and static element, and connected to the movable element and/or to the static element;

said movable element comprising the electrically conductive element of the user interaction element, a first intermediate conducting element on the opposite side of the movable element with respect to the electrically conductive element, and comprising an electrically conductive path extending through the movable element and connecting the electrically conductive element and the first intermediate conductive element;

said static element comprising a bridging element facing inwardly from the side section and electrically connected to at least one of the contact points, and a second intermediate conductive element on the opposite side of the static element with respect to the bridging element, and comprising an electrically conductive path extending through the static element and connecting the bridging element and the second intermediate conductive element;

wherein the movable and static elements are positioned with the first and second intermediate conductive elements facing each other, and whereby the biasing element is biased to separate the first and second intermediate conductive elements, and whereby the actuator is adapted such that, upon a predetermined minimal pressure on the movable element, the first and second intermediate conductive elements contact each other.

In a specific preferred embodiment, at least one user interaction point comprises an actuator, which comprises an movable element and a static element, wherein the movable element faces outwardly from the side section at which it is positioned, and wherein the actuator comprises at least two biasing elements positioned between the movable and static element, and connected to the movable element and/or to the static element;

said movable element comprising a first electrically conductive element, a first intermediate conducting element on the opposite side of the movable element with respect to the first electrically conductive element, and comprising a first electrically conductive path extending through the movable element and connecting the first electrically conductive element and the first intermediate conductive element;

said static element comprising a first bridging element facing inwardly from the side section and electrically connected to at least one of the contact points, and a second intermediate conductive element on the opposite side of the static element with respect to the first bridging element, and comprising a second electrically conductive path extending through the static element and connecting the second first element and the second intermediate conductive element;

said movable element comprising a second electrically conductive element, a third intermediate conducting element on the opposite side of the movable element with respect to the second electrically conductive element, and comprising a third electrically conductive path extending through the movable element and connecting the second electrically conductive element and the third intermediate conductive element;

said static element comprising a second bridging element facing inwardly from the side section and electrically connected to at least one of the contact points, said contact point different than the contact point electrically connected to the first bridging element, and a fourth intermediate conductive element on the opposite side of the static element with respect to the second bridging element, and comprising a fourth electrically conductive path extending through the static element and connecting the second bridging element and the fourth intermediate conductive element;

wherein the movable and static elements are positioned with the first and second intermediate conductive elements facing each other and with the third and the fourth intermediate conductive elements facing each other, and whereby the biasing elements are biased to separate the first and second intermediate conductive elements and to separate the third and fourth intermediate conductive elements, and whereby the actuator is adapted such that, upon a predetermined minimal pressure on the movable element, the first and second intermediate conductive elements and/or the third and fourth intermediate conductive elements contact each other.

In a further preferred embodiment, the movable and static elements are hingedly connected whereby the biasing elements are positioned at opposite sides with respect to the hinged connection, whereby the first and third intermediate elements are positioned at opposite sides of the movable element in view of said hinged connection, and whereby the second and fourth intermediate elements are positioned at opposite sides of the static element in view of said hinged connection.

The biasing elements may comprise components such as springs, or thin metal plates. Such metal plates can be slightly deformable, allowing the movable and static elements to be moved together. The actuator may be modified so that, when the metal plates is sufficiently deformed that the movable and static elements contact each other, the metal plate interacts with another element, thereby generating audible and/or tactile feedback (such as a click) to the user. The metal plate can be a bent plate attached to the movable or static element, which when unstressed, holds the movable and static elements (or at least the intermediate conductive elements) apart from each other. Upon application of sufficient pressure, the plate can partly ‘undo’ its bend to allow contact.

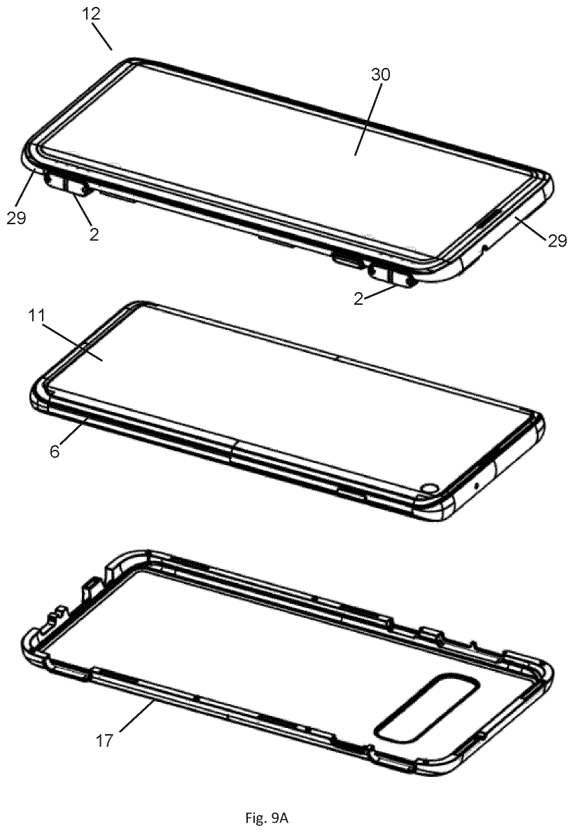

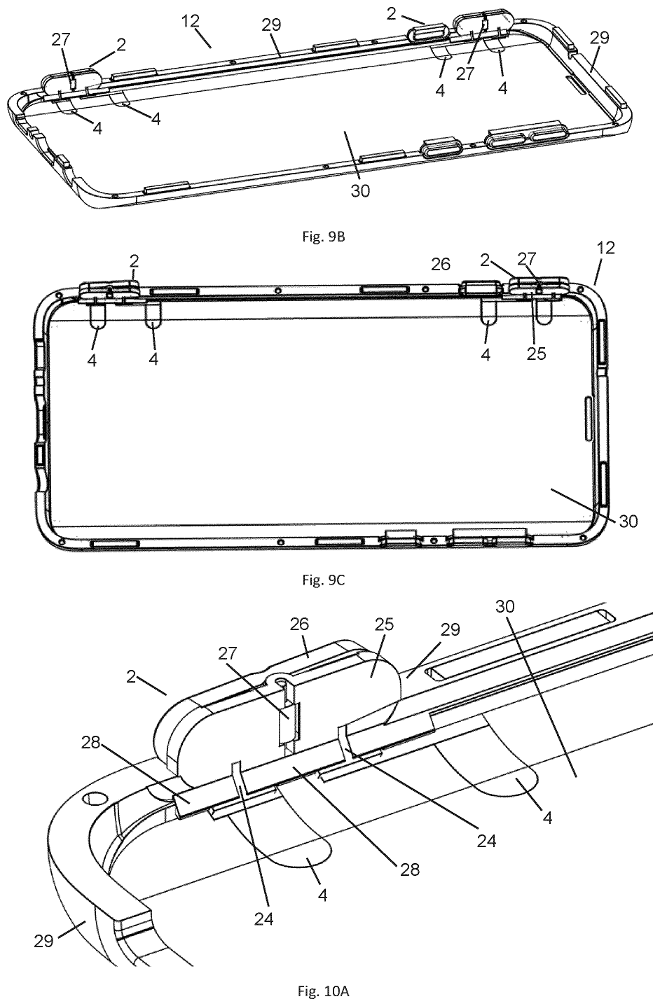

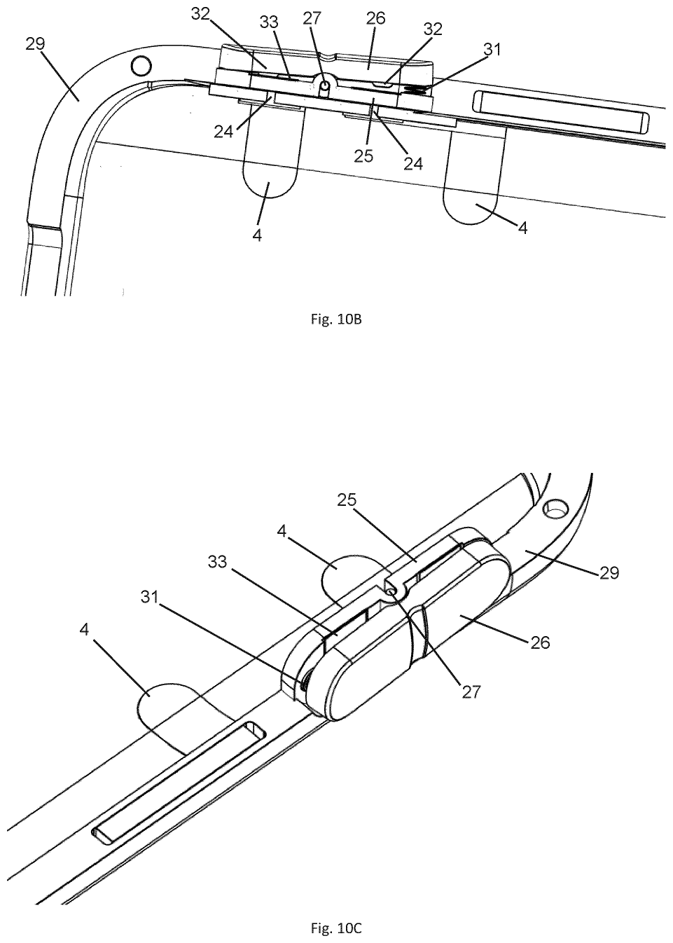

Potential embodiments of invention according to the above aspect are shown in FIGS. 9A-C and FIGS. 10A-C.

In this embodiment, the cover comprises a front panel (12) and a body (17) to hold the device (6) with a touchscreen (11). Note that the body can be left out in some variations, but is preferably present to fully encompass the device. The body and front panel can be connectable via a number of mechanisms, such as magnetic closures.

The front panel (12) comprises a front plane (30) and upstanding side sections (29) on the edges of said front plane. These side sections are designed to at least partially encompass the side edges of the device to be held, preferably over at least part of the circumference. At the side sections, one or more user interaction points (2), typically along the longest edges of the cover, are provided. As can be seen, the body (17) is adapted to complement the front panel (12), with openings for predetermined device ports (charger, camera, headphone) and adapted to fit around the user interaction points.

The front panel comprises contact points (4) at the inside thereof, i.e. facing the capacitive touchscreen of the device held in the cover. These contact points (4) are electrically connected or connectable to the electrically conductive element of the user interaction point (2). In the embodiment according to FIG. 9B and 9C, the user interaction point is a tiltable button, which allows the formation of an electrical pathway to two separate contact points (4). This can be achieved by using two separate or a single electrically conductive element on the user interaction point, establishing two separate pathways, the latter of which is visible in FIGS. 10A-C. The user interaction point (2) comprises a static element (25) and a movable element (26), which are hingedly connected via a hinge (27), allowing the ‘button’ to act with two different functions, and connecting to two separate contact points (4), as can be seen in FIG. 9C.

FIG. 10A shows a detailed view of a user interaction point (2) as mentioned in the previous paragraph, wherein part of the electrical connection between the user and the contact points (4) is visible, and shown as a first and a second bridging element (24), although as said embodiments with a single contact point and a single bridging element (24) are easily envisioned. The bridging elements (24) are shielded from contact with the (sometimes metallic, which would earth the entire pathway) edges of the device by a shielding element (28) which extends over part of the transition between side section (29) and front plane (30). In this embodiment, the bridging element (24) electrically contacts a further connecting section which leads to the contact point (4).

FIG. 10B and 10C exemplify the functionality of the tiltable actuator (tiltable via the hinged connection (27)) of the user interaction point, by showing the movable element (26) being pushed inward at the left side, causing a first intermediate conducting element (32) which is positioned at the inward-facing side of the movable element (26), to contact the second intermediate conducting element (33) which is positioned at the outward-facing side of the static element (25). Note that the first intermediate conducting element (32) is electrically connected to the electrically conductive element of the user interaction point (which is positioned at the outwardly-facing side of the movable element), thereby being placed at the same voltage. At the right side of the actuator, a biasing element can be seen in the form of a spring element (31), pushing apart the intermediate conducting elements (32 and 33) at the right side. Such a biasing element (31) is also present at the left side, but in this case at least partly depressed to allow contact. Without external interaction with the movable element, no contact is present at either side between the intermediate conducting elements (32 and 33).

From the second intermediate conducting elements (33), an electrically conducting path is present, through the static element (25), to the bridging section (24), which establishes an electrical connection to the contact point (4) which finally functions as the ‘fake’ fingerprint for interaction with the touchscreen.

Note that most, if not all, embodiments, both preceding as following hereafter, based on other aspects of the invention can be applied to the above aspect as well, and are considered to be part of the invention at hand.

### EXAMPLE

A preferred embodiment of the present invention is presented below. It is however clear that other embodiments can easily be contemplated within the scope of the invention. The presentation below should thus not be construed restrictive, but it should be realized that the skilled person will easily apply modifications to the presented example without reappraisal of the appended claims.

### Example 1

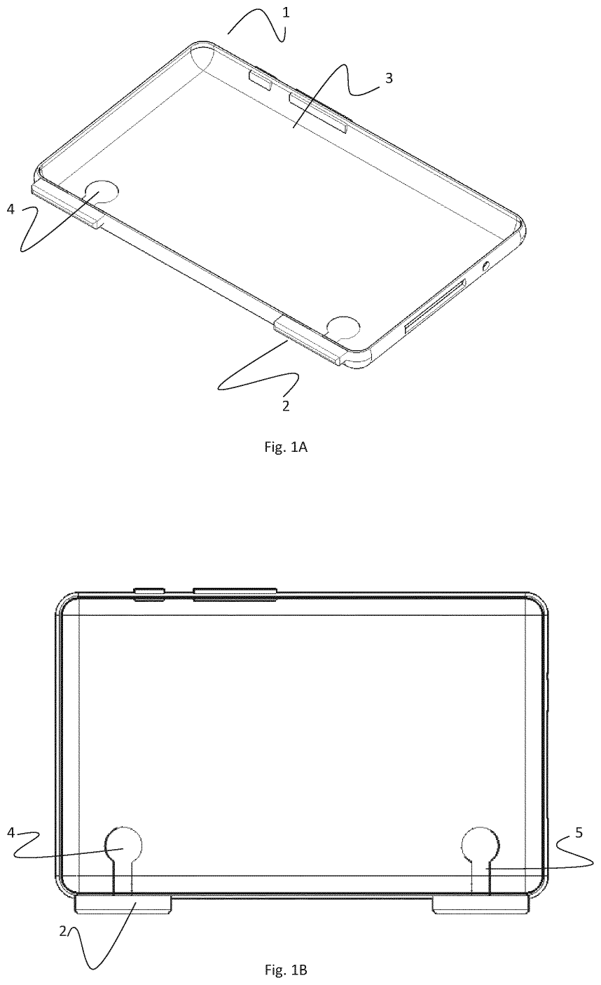

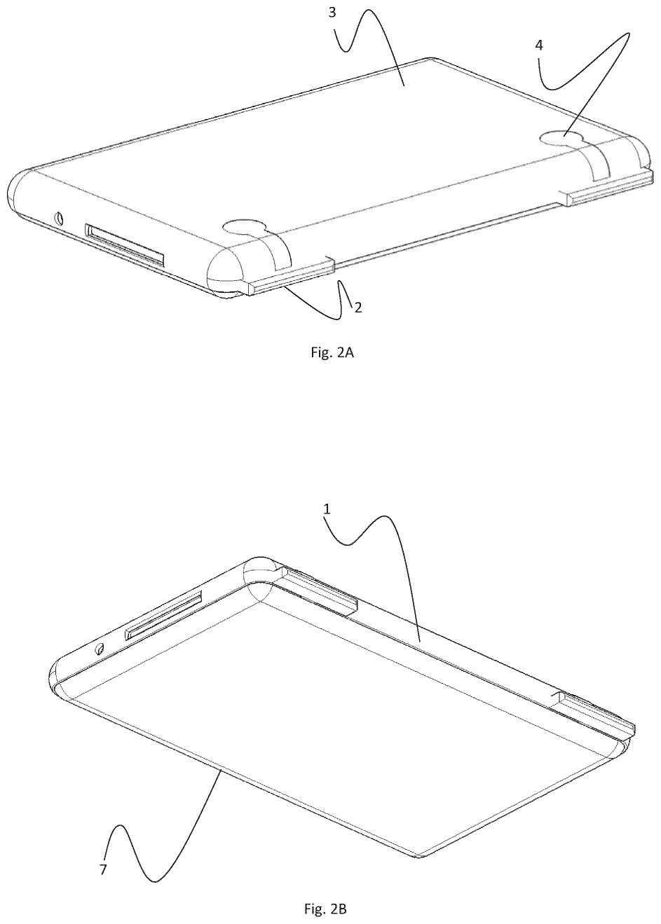

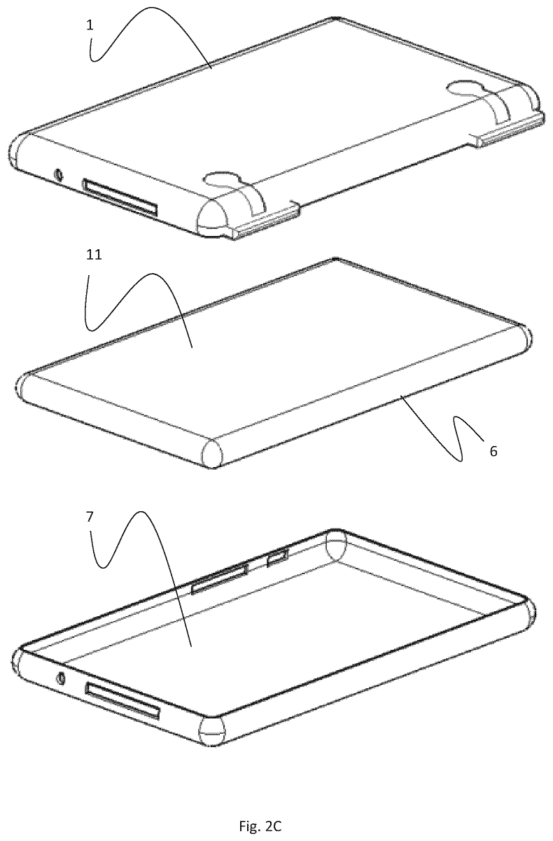

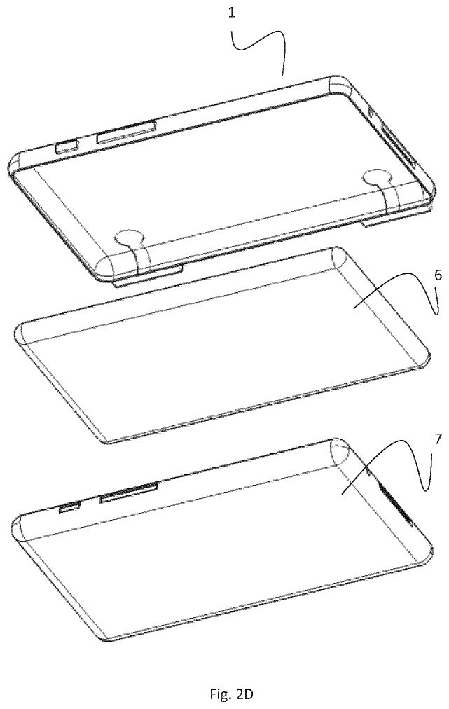

FIG. 1-2 show one preferred embodiment of the first version of present invention. The cover comprises
a body suitable for embracing a smartphone at four edges;
two user interaction points on one edge of the body, which comprises an exposed electrically conductive metal;
two contact points, each comprises an exposed electrically coiled conductor;
two connections, each electrically linking the electrically conductive metal of the user interaction point to the electrically coiled conductor of the contact point;
   wherein the cover fully covers the touchscreen, wherein the contact points are positioned at the side of the cover that faces the touchscreen.

The body (3) of the present example is first able to fully cover the touchscreen (11), wherein the contact points (4) are positioned on the body that covers the touchscreen. The body (3) embraces the electronic device (6) at four edges. Thus, it is ensured that when assembled on a smartphone, there is no plane displacement (horizontal or vertical) of the cover (1), such that the cover stays fixed. There are two user interaction points (2) positioned on the edge the body.

The body is made of transparent plastic, such that the present invention does not affect user's sight when using the touchscreen (11). The contact point (4) positioned on wherein is accordingly also transparent. The body (3) comprises one layer, wherein the contact point is positioned on the side that the faces touchscreen when the cover (1) assembled to a smartphone. The body and the contact point (4) are flat, such that when assembled one a smartphone, a rugged surface is avoided.

The user interaction point (2) and the contact point (4) are paired with each other, and linked by an electrical connection (5). Both said user interaction point (2) and said contact point (4) comprises electrically conductive element that is exposed. Thus an electrical circuit is built between the electrically conductive element in the user interaction point (2) and the electrically conductive element in the contact point (4). Such that when a user touches a finger on the user interaction point (2), specifically the electrically conductive metal (9), the static electricity is transferred from the user's finger to the contact point (4), specifically the electrically coiled conductor. In this way, the user touches the touchscreen (11) virtually. Present embodiment offers two pairs of the user interaction point (2) and the contact point (4).

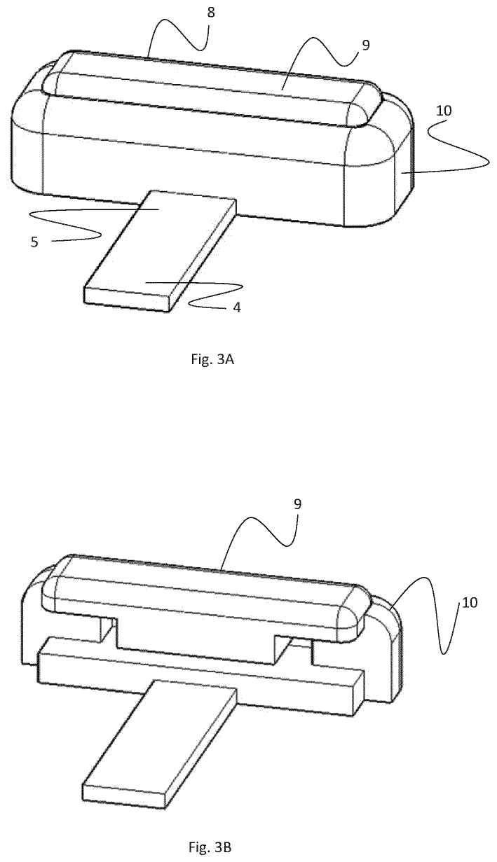

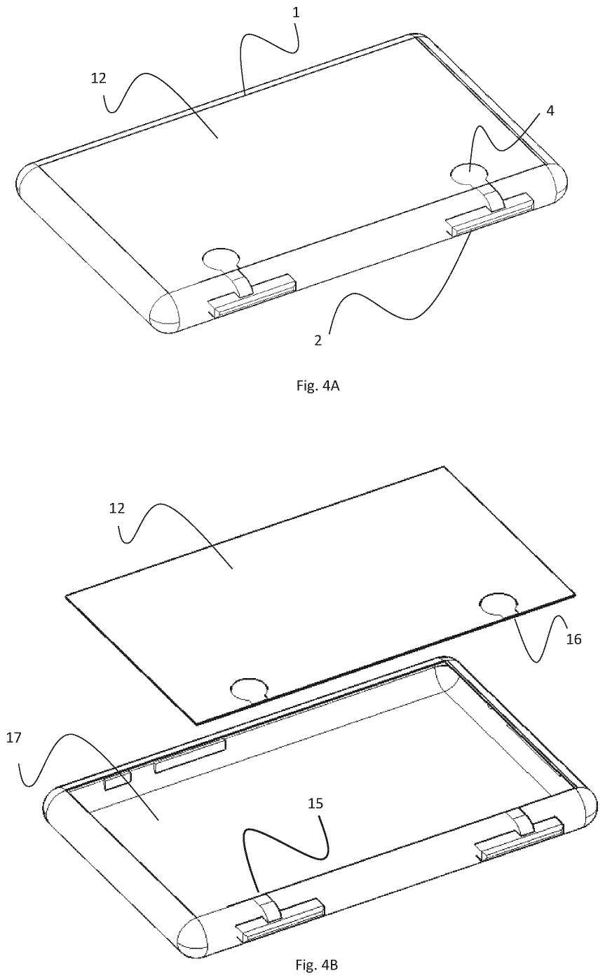

The contact point (4) and the electrical connection (5) are positioned close to the edges and the user interaction point (2) is positioned on the same edge, such that they do not affect user's sight when using the touchscreen. The user interaction point (2) is a button (8), as shown in FIG. 3. It comprises an electrically conductive metal (9) and an plastic housing (10). The button (8) is adapted to move upon exertion of force downwards, whereby such movement establishes an electrical connection between the electrically conductive metal (9) of the button (8) and the electrical connection (5), and eventually the electrically coiled conductor of the user interaction point (4). It is to confer a responding force to the user's finger when a user touches the button (2), essentially confers a push/tap experience to the user.

The contact point (4) comprises a coiled conductor that receives the static electricity from the user's finger, which is used to operate a certain point on the touchscreen (11). It reinforces the static electricity that applies on said point, essentially the electric field that applied on said point.

Present invention is designated for the smartphone as shown. When a user uses it during a video game, the user first needs to move two artificial touch points in the game (e.g. shooting, moving, speeding) to the edges of the touch screen to meet the contact points (4). During the game, the user holds the smartphone in their hands, with two thumbs touching some of the artificial points on the touchscreen and two forefingers touch the user interaction points (2). In this way, the user doesn't have to move their hands to operate the game.

In this embodiment, the cover is assembled to smartphone (6) with a coordinating base cover (7), which covers the four edges and the back of the smartphone (6). In principle, the base cover (7) can be any cover that fits in the cover (1). It offers additional protection to the smartphone and can be used as a normal phone cover. While applying the present embodiment, a user does not have to take off the base cover, and thus brings convenience and total protection to the smartphone.

Present embodiment comprises openings on the edges of the body (3), for volume button, on/off button and the passage of charging cable, headset cable, data transmission cable. The shape and dimensions are matched to the designated smartphone.

### Example 2

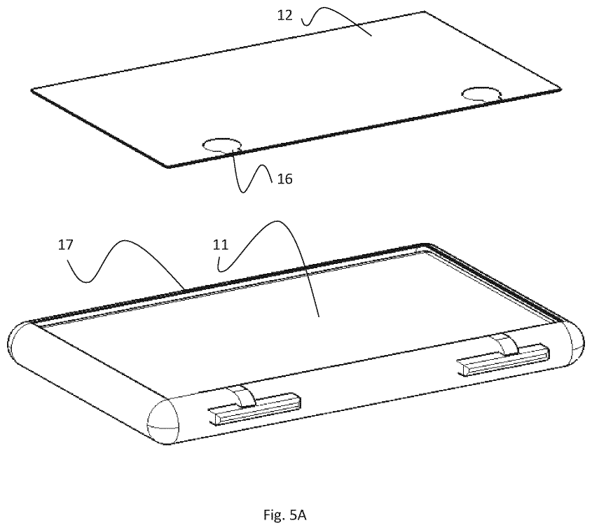

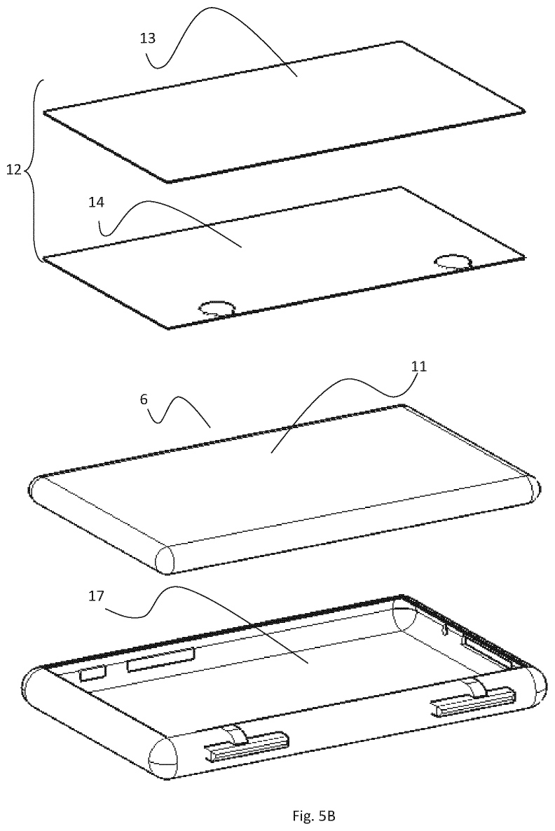

FIG. 4-5 show one preferred embodiment of the second version of present invention. The cover comprises:
a body suitable for embracing a smartphone at four, comprising:
   two user interaction points on the edge of the body, which comprises an exposed electrically conductive metal on each;
   two electric connector electrically linked to the electrically conductive metal of the user interaction point;
a front panel suitable for fully covering the touchscreen, and is adapted for being detachably connectable to the body, comprising;
   two contact point on the front panel that comprises an exposed electrically coiled conductor;
   two electric connector electrically linked to said contact point;
      wherein the contact point is positioned at the side of the front panel that faces the touchscreen, wherein the an electric connection is established between the electric connectors of the front panel and the body when said body and said panel are assembled.

The body (17) of the second version embraces the electronic device (6) at four edges. There are two user interaction point (2) positioned on the edge of the body (17). The body (17) further comprises two electric connector (15), that is exposed and electrically linked to the user interaction point (2). The cover (1) further comprises a separate front panel (12) comprising two contact point (4) and two electric connector (16) that is exposed and electrically linked to the contact point (4).

Said body (17) and said front panel (12) are adapted to be fixedly connected when assembled together with mechanical force and/or magnetic force on the edge, wherein the front panel (12) stays fixed when assembled. When assembled, the smartphone (6) is in between the front panel (12) and the body (17), with the touchscreen (11) facing the front panel (12). When not desired, said front panel (12) is detachable from said body (17).

The front panel (12) is made of transparent plastic, such that it does not affect user's sight when using the touchscreen (11). Accordingly, the contact point (4) is also transparent for the same reason. The front panel (12) comprises two layers. The contact point (4) is positioned on the layer (14) that is closest to the touchscreen (11) when assembled on a smartphone(6). An extra layer (13) is shielding the front panel from, for instance, scratch and wear. The contact point (4) and the electric connector (16) are positioned close to the edges of the front panel (12), such that they do not affect user's sight when using the touchscreen. The front panel (12), and the contact point (4) are flat, such that when assembled on an electronic device, a rugged surface is avoided.

The user interaction point (2) and contact point (4) are following the same design described in example 1.

When the front panel (12) and the body (17) are assembled, the electric connector (15) in the body (17) and the electric connector (16) in the panel (12) are electrically connected. In other words, said user interaction point (2), said electric connector (15), said electric connector (16) and said contact point (4) are grouped. In a preferred embodiment, the cover (1) contains two sets of above said group, preferably two sets of above said group.

Similar to example 1, the front panel (12) and the body (17) are light, thin and with enough stiffness to protect the smartphone. Similarly, when assembled, the cover is used in the same approach as described in example 1. When not desired, the user could merely take off the front panel and use the body as a normal phone cover. Present embodiment comprises openings on the edges of the body (17), for volume button, on/off button and the passage of charging cable, headset cable, data transmission cable. The shape and dimensions are matched to the designated smartphone.

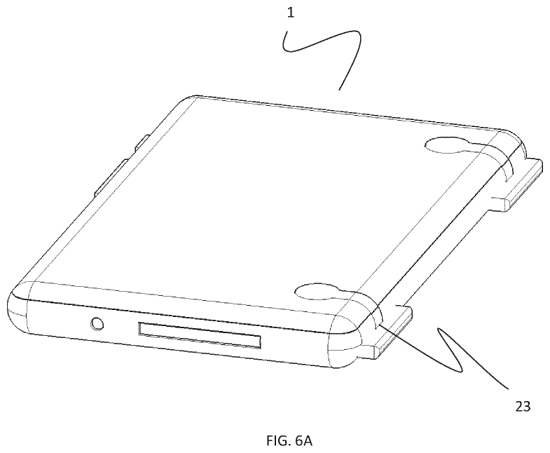

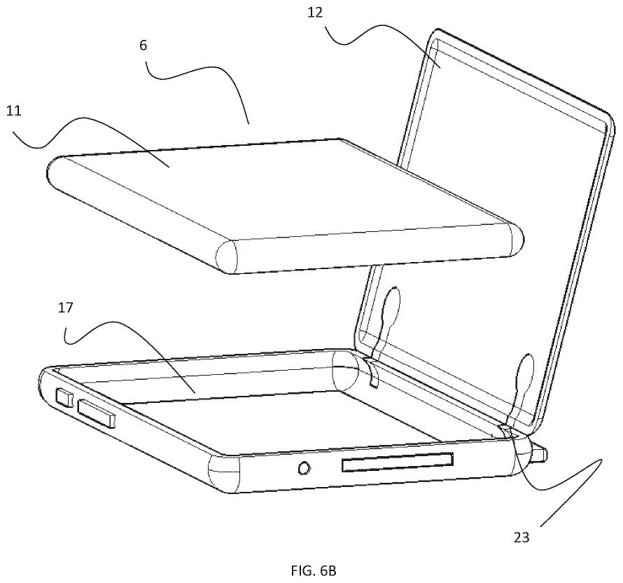

FIG. 6 show one further preferred embodiment of the second version of present invention. This embodiment comprises two hinges (23) that are placed at the edge of the body (17) and the front panel (12). It follows the design of the previous embodiment disclosed in example 2. While the difference is the connection between the front panel (12) and the body (17). This embodiment allows the cover to stay in one piece and thus avoiding an accidently missing part.

### Example 3

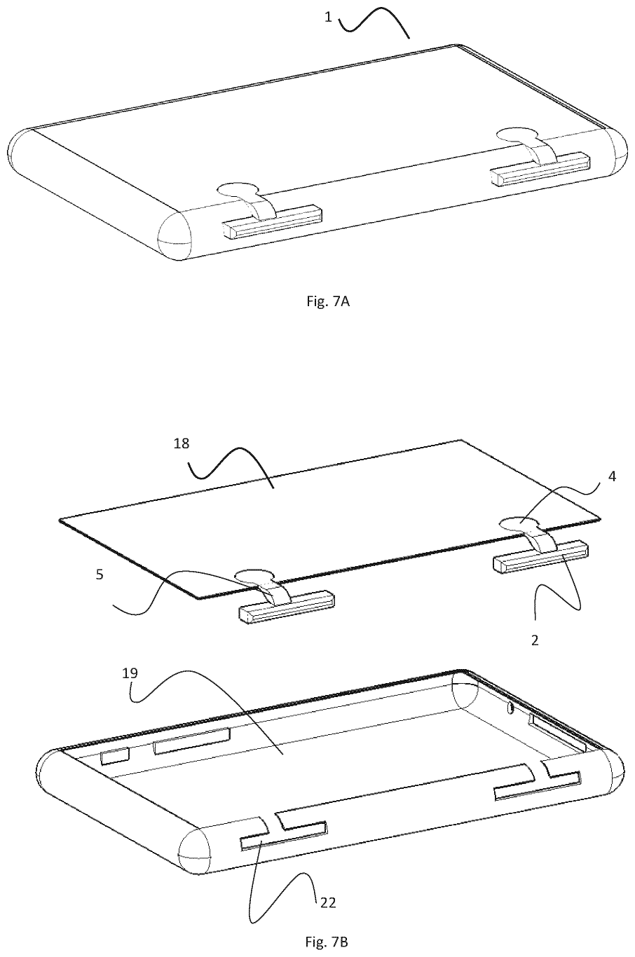

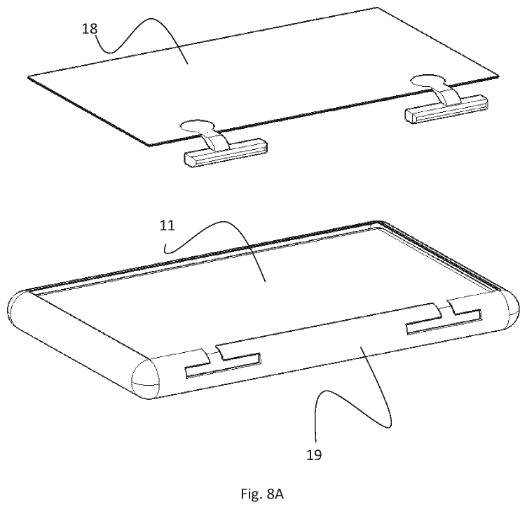

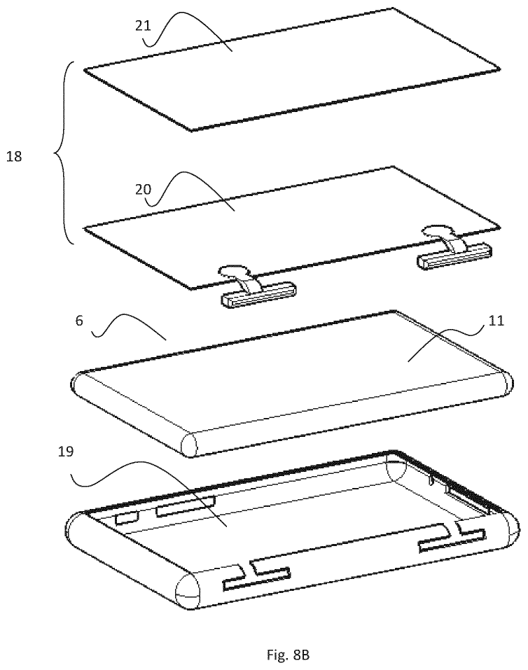

FIG. 7-8 show one preferred embodiment of the third version of present invention. The cover comprises:
a body suitable for embracing the smartphone at four edges;
a front panel suitable for fully covering the touchscreen, comprising;
   two user interaction points on the panel, which comprises an exposed electrically conductive metal;
   two contact points on the front panel, said contact point comprising an exposed electrically coiled conductor;
   two connection electrically linking the electrically conductive metal of the user interaction point and the electrically coiled conductor of the contact point;
      wherein the contact point is positioned at the side of the front panel that faces the touchscreen, and wherein said front panel is adapted for being detachably connectable to the body.

The front panel (18) comprises two user interaction point (2) on the panel, two contact point (4) on the front panel, two connections (5) electrically linking said user interaction point (2) and said contact point (4) in pair, specifically the electrically conductive element on both. Such that an electric circuit is established.

The front panel (18) is made of transparent plastic, such that it does not affect user's sight when using the touchscreen (11). Accordingly, the contact point (4) is also transparent for the same reason. The front panel (18) comprises two layers, wherein the contact point (4) is positioned on the layer (20) that is closest to the touchscreen (11) when assembled on an electronic device (6). An extra layer (21) is shielding the front panel from, for instance, scratch and wear.

Said user interaction point (2), said contact point (4) and said connection (5) are grouped. The front panel comprises two of such group. Said group is positioned close to the edge of the front panel (18). Such that they do not affect user's sight when using the touchscreen. The front panel (18), and the contact point (4) are flat, such that when assembled on an electronic device, a rugged surface is avoided.

The body (19) is suitable for embracing the smartphone at four edges. The body (19) comprises two openings (22) suitable for hosting the user interaction point (2).

Said body (19) and said front panel (18) are adapted to be fixedly connected when assembled together, with mechanical and/or magnetic force in said openings (22). When assembled, the electronic device (6) is in between the front panel (18) and the body (19), with the touchscreen (11) facing the front panel (18). When not desired, said front panel (18) is detachable from said body (19) and the body could serve as a normal phone cover.

The user interaction point (2), the connection (5) and the contact point (4) are following the same design described in example 1 and 2. Similar to example 1 and 2, the front panel (18) and the body (19) are light, thin and with enough stiffness to protect the smartphone. Similarly, when assembled, the cover is used in the same approach as described in example 1 and 2. Present embodiment comprises openings on the edges of the body (19), for volume button, on/off button and the passage of charging cable, headset cable, data transmission cable. The shape and dimensions are matched to the designated smartphone.

Using the examples to conclude the advantages of present invention, it i) assists a touch interaction at at least one virtual button on a touchscreen; ii) transfers physical touch to the touchscreen thus easy to use and assemble; iii) does not increase the dimension and weight significantly; iv) offers protection to the electronic device; v) is multifunctional as both a touch assistant and base cover; vi) comes with simple design and low manufacturing cost; vii) offers multiple choices for a range of preferences.

1. A cover for devices comprising a capacitive touchscreen, suitable for assisting a user with touch interaction on said touchscreen, comprising:
a body suitable for at least partly embracing the device at at least one or more edges and/or back of the device;
a front panel suitable for at least partly covering the touchscreen, said front panel comprising a flat front plane and one or more upstanding side sections at the edges of the front plane for embracing the device, comprising;
at least one user interaction point on one or more of the side sections of the front panel, which user interaction point comprises an exposed electrically conductive element;
at least one contact point on the front panel, said contact point comprising an exposed electrically conductive element;
a connection electrically linking the electrically conductive element of the user interaction point and the electrically conductive element of the contact point;
wherein the contact point is positioned at the side of the front panel that faces the touchscreen, and wherein said front panel is adapted for being detachably connectable to the body, preferably whereby the front panel and the body are essentially complimentary to each other.

2. The cover according to claim 1, wherein the user interaction points comprise actuators, said actuators comprising an electrically conductive path extending from a face of the side section at which the user interaction point is positioned facing outwardly from the front panel, to a face of said side section facing inwardly to the front panel, and wherein the actuator is adapted to, upon activation, establish an electrical connection between the electrically conductive element of the user interaction point to the electrically conductive path, whereby said electrically conductive element faces outwardly from the front plane, preferably whereby activation comprises moving at least part of the actuator towards the side section.

3. The cover according to claim 2, wherein the electrically conductive path extends through at least part of the actuator.

4. The cover according to claim 1, wherein the user interaction point comprises a mechanical actuator, whereby the actuator is adapted to move upon exertion of force towards the side section, whereby movement towards said side section establishes an electrical connection between the electrically conductive component of the actuator and the electrically conductive element of the user interaction point.

5. (canceled)

6. The cover according to claim 1, wherein at least the part of the cover that covers the touchscreen is transparent.

7. The cover according to claim 1, whereby the front panel is transparent.

8. The cover according to claim 1, wherein the body contains at least one opening on the edge that is suitable for receiving the user interaction point of the front panel.

9. The cover according to claim 1, wherein the user interaction point comprises a mechanical actuator, which comprises an electrically conductive component, whereby the actuator is adapted to move upon exertion of force in a first direction, whereby movement in said first direction establishes an electrical connection between the electrically conductive component of the actuator and the electrically conductive element of the user interaction point.

10. (canceled)

11. (canceled)

12. The cover according to claim 1 whereby the cover is a smartphone cover.

13. (canceled)

14. The cover according to claim 1, wherein there are at least two contact points and at least two interaction points, wherein the electrically conductive element of a first of the contact points and the electrically conductive element of a first of the interaction points are electrically connected; and the electrically conductive of the second of the contact points and the electrically conductive element of the second of the interaction points are electrically connected.

15. The cover according to claim 2, wherein the electrically conductive path extends through at least part of the actuator and, wherein the interaction point forms a protruding portion from the front panel, wherein the body comprises an opening suitable for receiving the protruding tip.

16. (canceled)

17. The cover according to claim 1, wherein at least part of the cover comprising the part that covers the touchscreen , comprises at least two layers, wherein the contact points and/or at least part of the connections are provided in and/or on one of the layers, and wherein at least one of the two layers is positioned to cover the layer comprising the contact points and/or at least part of the connections, functioning as a cover layer.

18. The cover according to claim 17, wherein the layer comprising the contact points and/or at least part of the connections is the layer more proximal to the touchscreen of the device than the at least one of the two layers covering the layer comprising the contact points and/or at least part of the connections when the cover is embracing the device, functioning as a cover layer.

19. The cover according to claim 16, wherein the connections are printed on or between the layers.

20. The cover according to claim 16, wherein at least the cover layer comprises glass and/or plastics.

21. The cover according to claim 1, wherein at least one, preferably all, of the user interaction points comprises a button which is adapted to discharge built-up static electricity upon release of the button by the user.

22. The cover according to claim 1, wherein the upstanding side sections extend over at least 75%, preferably at least 90% of the perimeter of the front panel, said side sections extending upwards from the front panel over a distance of at least 1.0 mm, preferably at least 2.0 mm, more preferably at least 4.0 mm.

23. The cover according to claim 2, wherein the electrically conductive path extends through at least part of the actuator, and wherein at least one user interaction point comprises at least two separated electrically conductive paths, each separated electrically conductive path connecting to a separate contact point, and wherein the user interaction point is adapted to, upon activation, establish an electrical connection from the electrically conductive element of the user interaction point to only one of said separated electrically conductive paths, preferably whereby said user interaction point comprises a hinging actuator.

24. The cover according to claim 1, wherein at least one user interaction point comprises an actuator, which comprises an movable element and a static element, wherein the movable element faces outwardly from the side section at which it is positioned, and wherein the actuator comprises at least one biasing element positioned between the movable and static element, and connected to the movable element and/or to the static element,
said movable element comprising the electrically conductive element of the user interaction element, a first intermediate conducting element on the opposite side of the movable element with respect to the electrically conductive element, and comprising an electrically conductive path extending through the movable element and connecting the electrically conductive element and the first intermediate conductive element;
said static element comprising a bridging element facing inwardly from the side section and electrically connected to at least one of the contact points, and a second intermediate conductive element on the opposite side of the static element with respect to the bridging element, and comprising an electrically conductive path extending through the static element and connecting the bridging element and the second intermediate conductive element;
wherein the movable and static elements are positioned with the first and second intermediate conductive elements facing each other, and whereby the biasing element is biased to separate the first and second intermediate conductive elements, and whereby the actuator is adapted such that, upon a predetermined minimal pressure on the movable element, the first and second intermediate conductive elements contact each other.

25. The cover according to claim 1, wherein at least one user interaction point comprises an actuator, which comprises an movable element and a static element, wherein the movable element faces outwardly from the side section at which it is positioned, and wherein the actuator comprises at least two biasing elements positioned between the movable and static element, and connected to the movable element and/or to the static element,
said movable element comprising a first electrically conductive element, a first intermediate conducting element on the opposite side of the movable element with respect to the first electrically conductive element, and comprising a first electrically conductive path extending through the movable element and connecting the first electrically conductive element and the first intermediate conductive element;
said static element comprising a first bridging element facing inwardly from the side section and electrically connected to at least one of the contact points, and a second intermediate conductive element on the opposite side of the static element with respect to the first bridging element, and comprising a second electrically conductive path extending through the static element and connecting the second first element and the second intermediate conductive element;
said movable element comprising a second electrically conductive element, a third intermediate conducting element on the opposite side of the movable element with respect to the second electrically conductive element, and comprising a third electrically conductive path extending through the movable element and connecting the second electrically conductive element and the third intermediate conductive element;
said static element comprising a second bridging element facing inwardly from the side section and electrically connected to at least one of the contact points, said contact point different than the contact point electrically connected to the first bridging element, and a fourth intermediate conductive element on the opposite side of the static element with respect to the second bridging element, and comprising a fourth electrically conductive path extending through the static element and connecting the second bridging element and the fourth intermediate conductive element;
wherein the movable and static elements are positioned with the first and second intermediate conductive elements facing each other and with the third and the fourth intermediate conductive elements facing each other, and whereby the biasing elements are biased to separate the first and second intermediate conductive elements and to separate the third and fourth intermediate conductive elements, and whereby the actuator is adapted such that, upon a predetermined minimal pressure on the movable element, the first and second intermediate conductive elements and/or the third and fourth intermediate conductive elements contact each other;
preferably whereby the movable and static elements are hingedly connected whereby the biasing elements are positioned at opposite sides with respect to the hinged connection, whereby the first and third intermediate elements are positioned at opposite sides of the movable element in view of said hinged connection, and whereby the second and fourth intermediate elements are positioned at opposite sides of the static element in view of said hinged connection.
